(19) United States
(12) Patent Application Publication
(10) Pub. No.: US 2005/0281587 A1
(43) Pub. Date: Dec. 22, 2005

(54) Wet type image forming apparatus

(75) Inventors: Motohiro Maseki, Saitama-ken (JP); Hidetaka Yamaguchi, Tokyo (JP); Hiroyuki Saito, Tokyo (JP); Masatoshi Takano, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/150,124

(22) Filed: Jun. 13, 2005

(30) Foreign Application Priority Data
Jun. 14, 2004 (JP) 2004-175555

(51) Int. Cl. G03G 15/10

(52) U.S. Cl. 399/237

(57) ABSTRACT

A wet type image forming apparatus includes a photoconductive drum, a toner supplying roller that supplies toner to the photoconductive drum, a developing solution applying roller uniformly applying the developing solution onto the toner supplying roller, a developing solution supplying roller supplying the developing solution to the developing solution applying roller, and two sidewall members respectively arranged on both sides of the pair of developing solution applying roller and the developing solution supplying roller. The two sidewall members closely contact side faces of the pair of developing solution applying roller and the developing solution supplying roller at both sides thereof, respectively. The circumferential surfaces of the developing solution applying roller and the developing solution supplying roller and the two sidewall members define a deposition space for depositing the developing solution, which is configured such that the developing solution is allowed to overflow only in the developing solution supplying roller side.

### BACKGROUND OF THE INVENTION

The present invention relates to a wet type image forming apparatus that forms an image with a developing solution containing a toner in a carrier solution.

Apparatuses that transfer a toner to a recording paper to thereby form an image include, for example, a dry type image forming apparatus, which applies a powder toner to a surface of a developing roller to form an image, and a wet type image forming apparatus, which applies a developing solution containing a toner in a carrier solution to a surface of a developing roller to form an image, as disclosed in Japanese Patent Provisional Publication No. P2002-214920A. The toner employed in the latter apparatus is finer than that employed in the former. Accordingly, the latter provides an image of a higher quality.

FIGS. 1 and 2 show an example of the conventional wet type image forming apparatus around an anilox roller 302 which serves to uniformly apply a developing solution DS onto the surface of a developing roller. FIG. 1 is a perspective view from an upper direction showing the structure, and FIG. 2 is a cross-sectional view taken along an axial direction of the structure shown in FIG. 1.

The developing solution DS is picked up by a pickup roller 306 from a developing solution tank, and is applied to an add roller 304. Then, the ink is deposited in a space defined by the anilox roller 302 and the add roller 304 which is configured to rotate while contacting the anilox roller. The amount of the developing solution DS that has adhered to the surface of the anilox roller 302 is, after passing through the contacted interface, accurately adjusted by a blade which contacts the surface, thereby the ink being uniformly applied onto the surface of the developing roller.

When the developing solution DS is more than fully deposited in the space, the developing solution DS overflows beyond the end portions of the anilox roller 302 and the add roller 304, and drops on a region around the developing solution tank. Since the developing solution DS has a relatively higher viscosity and hence a lower fluidity, a majority of the developing solution DS remains where it has dropped (i.e. in the periphery of the developing solution tank) as shown in FIG. 2, and barely flows toward the central portion of the developing solution tank. Therefore, the axial distribution of the developing solution DS lifted by the pickup roller 306, as well as the axial distribution of the developing solution DS applied to the anilox roller 302 become uneven because of the uneven distribution of the developing solution DS in the developing solution tank. Consequently, on the surface of the developing roller, the developing solution DS is thickly distributed in a peripheral portion and thinly distributed in a central portion. Such uneven application of the developing solution DS to the surface of the developing roller results in uneven development of a latent image on the photoconductive drum. A solution of such a problem has been proposed, for example, in a wet type image forming apparatus disclosed in Japanese Patent Provisional Publication No. P2000-250318A.

However, the wet type image forming apparatus according to Publication No. P2000-22250318A requires a space in which the developing solution is substantially enclosed, and further a control device for controlling the amount of the developing solution to be supplied to the space, which results in upsizing of the apparatus and increase of the manufacturing cost.

### SUMMARY OF THE INVENTION

In view of the foregoing situation, the present invention is advantageous in that an improved wet type image forming apparatus is provided, which apparatus is capable of preventing uneven development without incurring upsizing of the apparatus and increase of the manufacturing cost.

According to aspects of the invention, there is provided a wet type image forming apparatus that forms an image with a developing solution containing toner in a carrier solution. The image forming apparatus includes a photoconductive drum on which a latent image is formed, a toner supplying roller that supplies toner to a circumferential surface of the photoconductive drum, a pair of a developing solution applying roller and a developing solution supplying roller, the developing solution applying roller uniformly applying the developing solution onto a circumferential surface of the toner supplying roller, the developing solution supplying roller contacting the circumferential surface of the developing solution applying roller to supply the developing solution to a circumferential surface of the developing solution applying roller, and two sidewall members respectively arranged on both sides of the pair of developing solution applying roller and the developing solution supplying roller, the two sidewall members closely contacting side faces of the pair of developing solution applying roller and the developing solution supplying roller at both sides thereof, respectively. The circumferential surface of the developing solution applying roller, the circumferential surface of the developing solution supplying roller, and the two sidewall members define a deposition space for depositing the developing solution, the deposition space being configured such that the developing solution is allowed to overflow only in the developing solution supplying roller side.

Optionally, the developing solution supplying roller and the developing solution applying roller may be arranged such that an uppermost portion of the developing solution supplying roller is lower than an uppermost portion of the developing solution applying roller.

Further, the position of the upper ends of the sidewall members may be higher than the uppermost portion of the developing solution applying roller.

The wet type image forming apparatus may further include a developing solution collecting tank configured to collect therein the developing solution that has not been consumed, and a developing solution pickup device that supplies the developing solution collected in the developing solution collecting tank into the space defined by the circumferential surface of the developing solution applying roller, the circumferential surface of the developing solution supplying roller, and the two sidewall members.

The developing solution applying roller and the developing solution supplying roller may have a substantially same axial length, and are disposed such that the end faces on each axial side are flush with each other.

Optionally, the wet type image forming apparatus may further include a casing accommodating at least the developing solution applying roller and the developing solution supplying roller, the housing having a pair of walls respectively facing the end faces of the pair of developing solution applying roller and the developing solution supplying roller, respectively. Further, the sidewall members may include elastic members arranged between the pair of walls and the end faces, respectively, the sidewall members being elastically deformed so as to closely contact the respective end faces of the pair of developing solution applying roller and the developing solution supplying roller.

In this case, the elastic members may include rubber members. The rubber members may be made of urethane rubber or silicon rubber.

Optionally, the sidewall members may include metal plates arranged to closely contact the respective end faces of the pair of developing solution applying roller and the developing solution supplying roller.

Further, the wet type image forming apparatus may include a housing accommodating at least the pair of developing solution applying roller and the developing solution supplying roller, the housing having a pair of walls respectively facing the end faces of the pair of developing solution applying roller and the developing solution supplying roller, respectively, and biasing members provided between the metal plates and the end faces of the pair of developing solution applying roller and the developing solution supplying roller to urge the metal plates toward the end faces the pair of developing solution applying roller and the developing solution supplying roller.

### BRIEF DESCRIPTION OF THE ACCOMPANYING DRAWINGS

FIG. 1 is a perspective view showing a structure around an anilox roller in a conventional wet type image forming apparatus;

FIG. 2 is a cross-sectional view showing a structure around the anilox roller in the conventional wet type image forming apparatus;

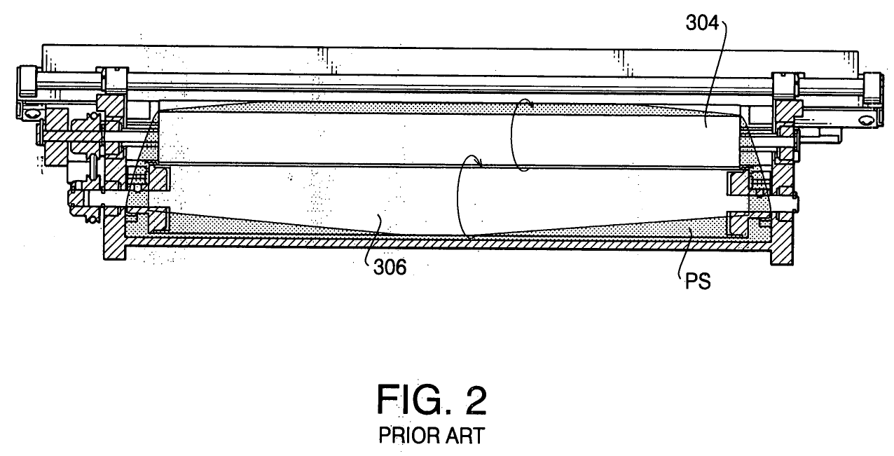

FIG. 3 is a cross-sectional side view showing a structure of a wet type printer according to an embodiment of the present invention;

FIG. 4 is a cross-sectional side view showing a structure around a measuring roller in the wet type printer according to the embodiment of the present invention;

FIG. 5 is a perspective view showing a structure around the measuring roller in the wet type printer according to the embodiment of the present invention;

FIG. 6 is a cross-sectional view showing a structure around the measuring roller in the wet type printer according to the embodiment of the present invention; and

FIG. 7 is a fragmentary perspective view showing a structure around a sealing device of a space S in a wet type printer according to another embodiment of the present invention.

### DETAILED DESCRIPTION OF THE EMBODIMENTS

Referring to the accompanying drawings, a wet type printer according to an embodiment of the present invention will be described in detail.

### First Embodiment

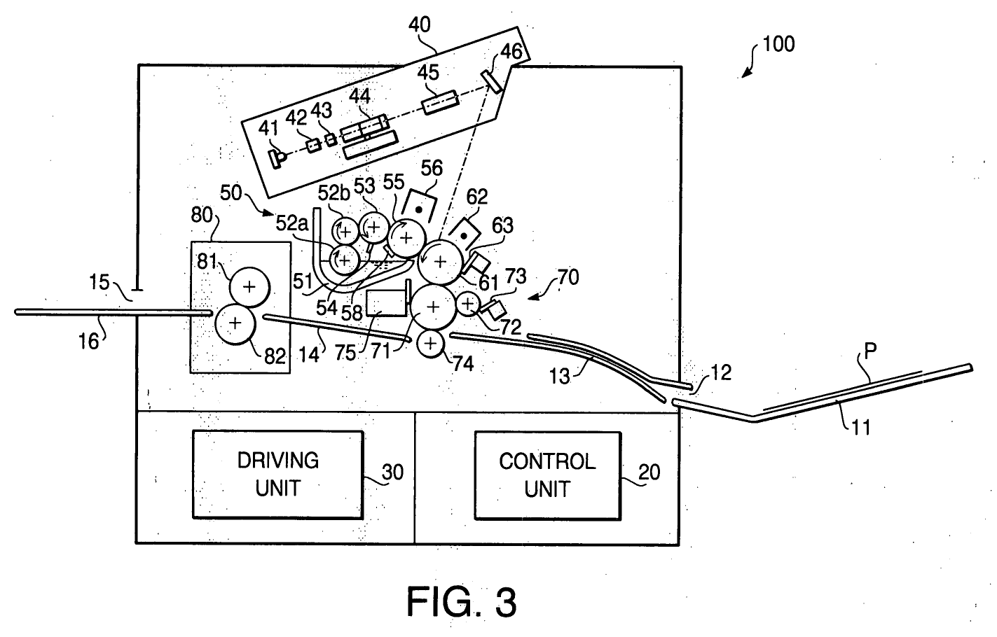

FIG. 3 is a cross-sectional side view showing a structure of a wet type printer 100 according to an embodiment of the present invention. The wet type printer 100 is an apparatus that forms an image with a developing roller that carries, on its surface, a developing solution DS containing a toner in a carrier solution, and more specifically an apparatus that receives print information (i.e., character and/or image information) from an external apparatus such as a computer, and prints out the letter or image on a recording paper P in accordance with a so-called electrophotographic imaging process.

The wet type printer 100 generally includes a control unit 20 that controls a printing process, sheet feeding operation and so on, a driving unit 30 that drives various mechanisms, a laser scanning unit (hereinafter, abbreviated as “LSU”) 40 that outputs a laser beam modulated according to print information, a developing unit 50 that develops a latent image formed according to print information with a developing solution DS, a transfer unit 70 that transfers a toner image developed by the developing unit 50 at a transfer position onto the recording paper P, a feeding mechanism that feeds the recording paper P, and a fixing unit 80 that permanently fixes the toner image which has been transferred on the recording paper P.

The driving unit 30 serving as a driving source of the mechanisms in the wet type printer 100 includes a plurality of actuators that drive the respective mechanisms. All of these actuators are connected to the control unit 20, to be driven under the control of the control unit 20. The driving unit 30 can cause a rotation of, for example, a developing roller 55 and photoconductive drum 61 included in the developing unit 50, and a heat roller 81 included in the fixing unit 80.

On a side face of a housing of the wet type printer 100, a paper inlet 12 is formed, through which the recording paper P is introduced into the printer 100, and a paper tray 11 for storing the recording paper P is attached at the paper inlet 12. On the opposite side face of the housing, a paper outlet 15 and a receiver tray 16 are provided. The recording paper P, upon being introduced into the wet type printer 100 through the paper inlet 12, is fed along a paper path 13 to reach the transfer position defined by the transfer unit 70, where the toner image is transferred onto the surface of the recording paper P. Thereafter the recording paper P is fed along a paper path 14 to reach a fixing position defined by the fixing unit 80 for fixation of the toner image. Then, the recording paper P is discharged from the wet type printer 100 through the paper outlet 15.

The toner image corresponding to the print information to be transferred to the recording paper P at the transfer unit 70 is initially generated by the control unit 20 and the LSU 40. The LSU 40 includes a laser diode 41 serving as a light source, a collimating lens 42, a cylindrical lens 43, a polygon mirror 44, an imaging lens 45 and a deflecting mirror 46. Instead of the LSU 40, an LED (Light Emitting Diode) and a reducing optical system may be employed as the exposure method.

The laser diode 41 is driven under the control of the control unit 20. That is, the laser diode 41 is turned on and off (i.e. modulated) according to the print information, thereby emitting a laser beam modulated carrying the image information. The laser beam irradiated by the laser diode 41 enters the collimating lens 42, which converts the laser beam from a diffused luminous flux into a parallel luminous flux.

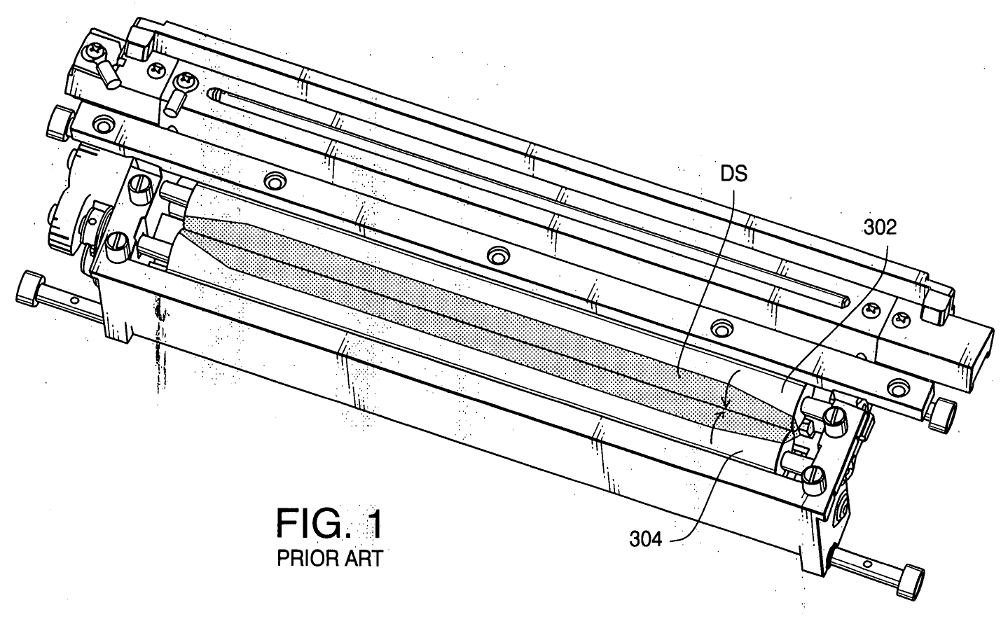

The laser beam converted into a parallel luminous flux (i.e., collimated) is converged by the cylindrical lens 43 solely in a sub-scanning direction so that the laser beam is converged on a plane, in the sub-scanning direction, close to a reflecting surface of the polygon mirror 44. It is to be noted that the sub-scanning direction herein referred to designates a direction parallel to a plane of FIG. 1 (a direction orthogonal to the rotating shaft of the photoconductive drum 61, i.e. a tangent on a circumferential surface thereof), while a direction orthogonal to the sub-scanning direction, i.e. a direction in which the laser beam is scanned on the photoconductive drum 61 (an axial direction on the photoconductive drum 61) is herein defined as a main scanning direction.

The polygon mirror 44 is rotated by a motor (not shown), and hence the laser beam linearly converged (converged only in a sub-scanning direction) by the cylindrical lens 43 substantially at a section of the reflecting surface of the polygon mirror 44 is deflected so as to be scanned in a main scanning direction, and enters the imaging lens 45. The laser beam passed through the image forming lens 45 scans in a main scanning direction at a predetermined speed on the photoconductive drum 61. The laser beam thus converted is deflected by the deflecting mirror 46 toward the photoconductive drum 61, to thereby form an image on the photoconductive drum 61. At this stage, since the laser beam is modulated with the progress of the main scanning, a scanning line according to the print information is formed on the photoconductive drum 61. Also, since the photoconductive drum 61 rotates in a sub-scanning direction, a plurality of scanning lines are formed in a sub-scanning direction on the photoconductive drum 61. As a result, a two-dimensional latent image corresponding to the print information is formed on the photoconductive drum 61. It should be noted that the reflecting surface of the polygon mirror 44 and the photoconductive drum 61 have a conjugate relationship with respect to the sub-scanning direction. Accordingly, the scanning line spacing is not shifted in a sub-scanning direction, even when the polygon mirror 44 incurs a facet error.

The developing unit 50 includes a developing solution tank 51 that stores the developing solution DS and also serves as a housing that accommodates each component of the developing unit 50, a pickup roller 52a that picks up the developing solution DS from the developing solution tank 51, an add roller 52b that deposits the developing solution DS supplied by the pick up roller 52a, a measuring roller 53 to which the deposited developing solution DS is supplied, an adjusting blade 54 that adjusts an amount of the developing solution DS supplied to the measuring roller 53, a developing roller 55 that carries the adjusted developing solution DS, a developing roller charger (hereinafter, referred to as a corona charger) 56 that charges the developing roller 55, and a developing roller cleaning blade 58 the scrapes off the developing solution from the surface of the developing roller 55, for removal. On the surface of the photoconductive drum 61, a latent image is formed by the LSU 40 based on the print information. A photoconductive drum charger (hereinafter, referred to as a corona charger) 62 charges the photoconductive drum 61 for adhering the toner according to the latent image onto the surface of the photoconductive drum 61. The photoconductive drum 61 and the corona charger 62 are located close to the developing unit 50. A photoconductive drum cleaning blade 63 is located close to the developing unit 50, for scraping off the toner remaining on the surface of the photoconductive drum 61 without being transferred to an intermediate transfer roll 71, to be later described, included in the transfer unit 70.

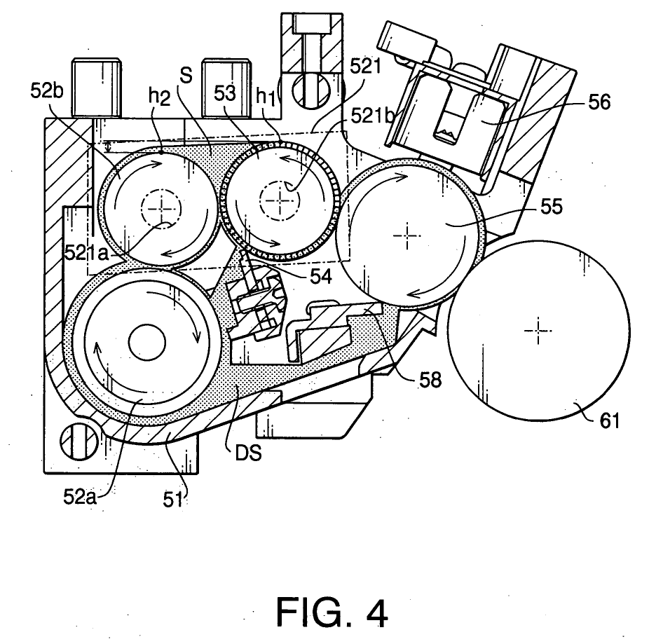

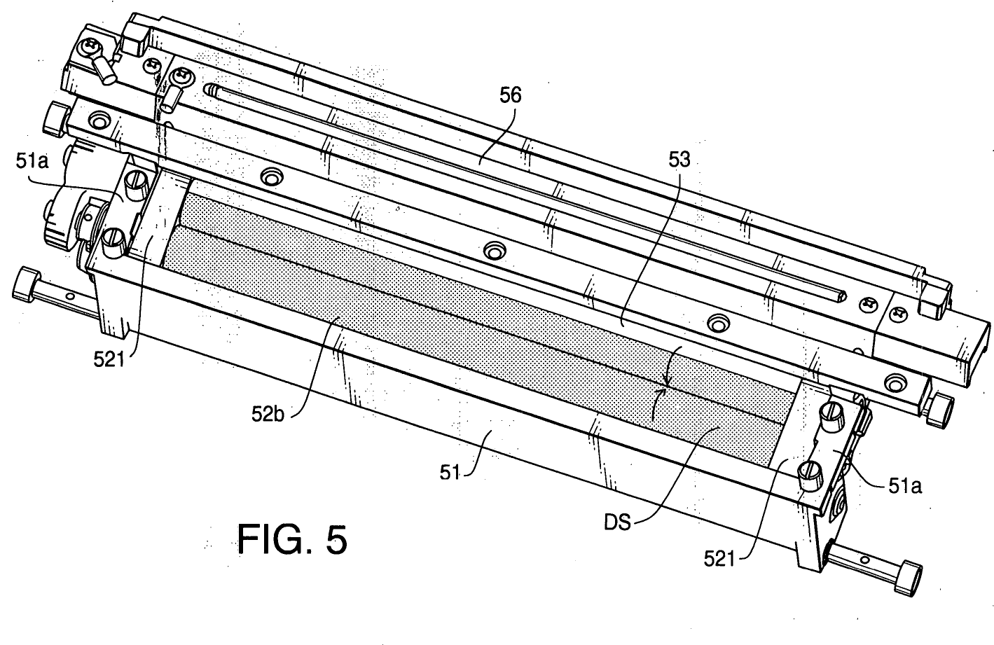

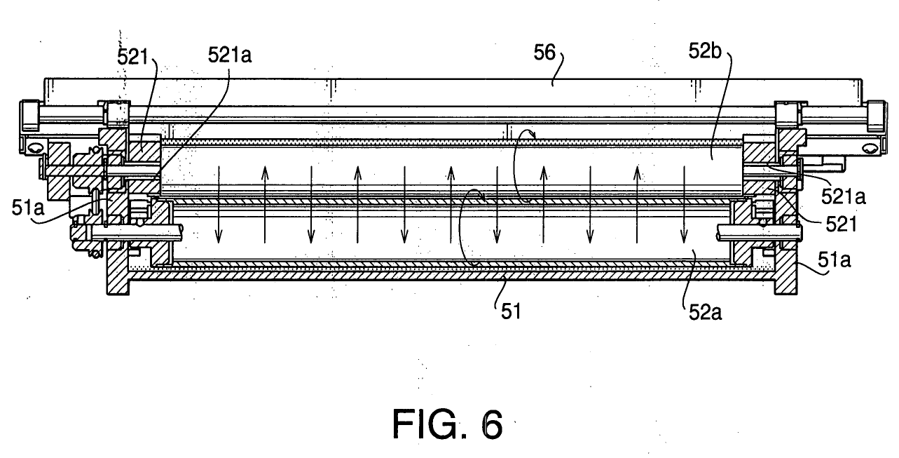

Next, a flow of the developing solution DS inside the developing unit 50 as well as a developing process performed therein will be described. FIGS. 4 to 6 show a structure around the measuring roller 53. FIG. 4 is a cross-sectional side view of the structure taken along a plane perpendicular to a rotational axis of the measuring roller 53, FIG. 5 is a perspective view of the structure viewed from an upper direction, and FIG. 6 is a cross-sectional view of the structure taken alone a plane parallel with the axis of the measuring roller 53.

The developing solution tank 51 serving also as a housing includes a wall portion 51a disposed, when the assembled, to cover the respective end faces of the rollers. Rotary shafts of the rollers are supported by openings formed on the wall portion 51a, respectively.

Most of the portion of the pickup roller 52a is dipped in the developing solution DS deposited in the developing solution tank 51. When the pickup roller 52a is driven to rotate clockwise as shown in FIGS. 3 and 4, the developing solution DS that has adhered to the surface of the pickup roller 52a is lifted up and supplied to the add roller 52b, upon reaching a region close to the interface between the pickup roller 52a and the add roller 52b. The add roller 52b rotates clockwise as shown in FIGS. 3 and 4, so as to supply the developing solution DS that has adhered on its surface to the measuring roller 53. It is to be noted that the developing solution DS stored in the developing solution tank 51 is agitated by an agitating mechanism (not shown). Further, the temperature of the developing solution DS is controlled by a temperature control system (not shown).

The measuring roller 53 is driven to rotate counterclockwise as shown in FIGS. 3 and 4, and provided with a plurality of grooves formed at a predetermined interval on its surface. The adjusting blade 54 contacts the surface of the measuring roller 53 for scraping off an excessive portion of the developing solution DS stuck thereto.

The elastic members 521 may be, for example, molded components constituted of urethane rubber or silicone rubber, which are resistant against a developing solution, and each includes a shaft hole 521a for receiving the rotary shaft of the add roller 52b, as well as a shaft hole 521b for receiving the rotary shaft of the measuring roller 53. The elastic members 521 are elastically deformed at positions adjacent to the respective end faces of the add roller 52b and the measuring roller 53, and between the wall portion 51a and the respective end faces of these two rollers 52b and 53, with the rotary shafts of the same rollers inserted through the respective shaft holes 521a and 521b. Since the elastically deformed elastic members 521 generate a force to restore the initial state, the elastic members 521 apply such force to the respective end faces and the wall portion 51a, so as to be closely pressed-contacted with the wall portion 51a and end faces of the rollers 52b and 53. It should be noted that, according to the embodiment, the add roller 52b and the measuring roller 53 are formed to have the same axial length, and disposed such that the respective end faces become flush with each other when assembled in the developing solution tank 51.

When the add roller 52b, the measuring roller 53 and the two elastic members 521, are assembled in the developing solution tank 51, a space S is formed. The space S has a bottom portion delimited by the contact interface between the two rollers 52b and 53, and is surrounded by a part of the surfaces of the two rollers and by the two elastic members 521. It should be noted that the add roller 52b is arranged such that the uppermost portion h₂ thereof is located lower than the uppermost portion h₁ of the measuring roller 53, so as to prevent the developing solution DS deposited in the space S from overflowing beyond the measuring roller 53 and from sticking to the developing roller 55 and the photoconductive drum 61 and, as will be subsequently described, to apply the developing solution DS uniformly to the surface of the developing roller 55. Accordingly, the space S is closed at the front portion (more precisely on the measuring roller 53 side) and both side portions, while open at the top, and a part of the rear portion (corresponding to the height gap between the uppermost portions h₁ and h₂, on the add roller 52b side) over the entire width (i.e., the entire width of the add roller 52b or the measuring roller 53). In order to have the area of the surface of the measuring roller 53 dipped in the developing solutions as much as possible, the position of the uppermost portion h₂, in the height direction, is close to the position of the uppermost portion h₁.

Since both lateral (side) portions of the space S are closed by the elastic members 521, the developing solution DS can only overflow beyond the front portion of the space S, and drops into the developing solution tank 51. Whereas, the uppermost portion h₂ of the add roller 52b is lower than the uppermost portion h₁ of the measuring roller 53 as described above. Further, the upper end of the elastic members are higher than the uppermost portion h₁ of the measuring roller 53. Accordingly, a portion of the developing solution DS that has exceeded the capacity of the space S flows over the entire axial length of the add roller 52b, by which the developing solution DS naturally drops over the entire width of the developing solution tank 51. Consequently, the developing solution DS is deposited relatively uniformly in the peripheral portion as well as in the central portion of the developing solution tank 51, instead of concentrating in the peripheral portion as in the conventional structure. It should be noted that, although FIG. 6 includes upwardly and downwardly oriented arrows to indicate the flow of the developing solution DS, two stacked layers of the developing solution DS are present on the surface of the add roller 52b (and the pickup roller 52a), namely a layer of the developing solution DS which is picked up from the developing solution tank 51 (a layer contacting the surface) and another layer of the developing solution DS overflowing out of the space S (a layer separate from the surface) are stacked.

The uniform distribution of the developing solution DS deposited in the developing solution tank 51 over the entire width provides uniform distribution of the developing solution DS picked up onto the pickup roller 52a (and the add roller 52b) over the entire width thereof. As a result, the developing solution DS supplied to the measuring roller 53 is also uniformly distributed over the entire width, and thus uneven application of the developing solution DS to the developing roller 55 will not occur.

In the space S, the developing solution DS is adhered to the entire surface of the measuring roller 53. Then a portion of the developing solution DS that has reached the contact interface between the add roller 52b and the measuring roller 53 is scraped (i.e. adjusted) by the adjusting blade 54. Another portion of the developing solution DS which is supplied to the measuring roller 53 will not be scraped, since such portion is retained in the grooves. Accordingly, only the portion retained in the grooves, i.e. the accurately adjusted portion of the developing solution DS remains on the surface of the measuring roller 53, and consequently the developing solution DS can be uniformly applied to the developing roller 55, which is in rotational contact with the measuring roller 53.

The developing solution contains the toner in a uniform concentration, immediately after the application to the developing roller 55 from the measuring roller 53. Accordingly, the toner is uniformly distributed in the carrier solution, in a region close to the interface between the measuring roller 53 and the developing roller 55. The developing roller 55 rotates in the clockwise direction, according to the orientation of FIGS. 3 and 4. Therefore, the developing solution having a uniform concentration is carried by the surface of the developing roller 55, to thereby pass under the corona charger 56.

The developing roller 55 has a surface constituted of a conductive material, so that such surface is uniformly charged by a corona charging effect of the corona charger 56. The charging effect generates an electric field between the surfaces of the developing roller 55 and the developing solution DS, thereby causing the toner, which has been uniformly distributed in the carrier solution DS, to move toward the surface of the developing roller 55 and to closely stick thereto. In other words, the developing solution DS is split into two layers, namely a layer containing only the carrier solution and the other layer containing the toner in a higher concentration than the initial state in the carrier solution. Obviously it is the latter layer that contacts the surface of the developing roller 55.

The developing solution DS split into two layers then reaches the position to contact the photoconductive drum 61. On the surface of the photoconductive drum 61, the latent image corresponding to the print information is formed, by the beam emitted from the LSU 40. The photoconductive drum 61 is charged so as to gain a higher potential than that of the developing roller 55, by corona charger 62. However, the region where the latent image is formed gains a lower potential than the developing roller 55, because of an effect of the laser beam. Accordingly, between the region excluding the latent image on the photoconductive drum 61 and the surface of the developing roller 55, the toner remains closely stuck to the lower-potential region, i.e. the surface of the developing roller 55, without being transferred to the region where the latent image is not provided. Consequently, the region excluding the latent image is not developed. By contrast, between the latent image region on the surface of the photoconductive drum 61 and the surface of the developing roller 55, the toner performs electrophoresis toward the lower-potential region, i.e. the latent image region on the surface of the photoconductive drum 61, thus to adhere thereto. That is how the latent image on the photoconductive drum 61 is developed, to turn into a toner image.

The developing solution DS containing the toner, which has not been utilized in the developing process, is scraped off by the developing roller cleaning blade 58 disposed in contact with the surface of the developing roller 55, and collected into the developing solution tank 51.

The toner image developed on the surface of the photoconductive drum 61 is transferred to the recording paper P by the transfer unit 70. The transfer unit 70 includes an intermediate transfer roll 71, a carrier solution squeeze roll 72, a carrier solution cleaning blade 73, a secondary transfer roll 74, and an intermediate transfer roll cleaning unit 75.

To the intermediate transfer roll 71, a transfer bias of a reverse polarity to the toner is applied, so that the toner image developed on the surface of the photoconductive drum 61 is transferred as a primary step to the intermediate transfer roll 71, at the interface between the photoconductive drum 61 and the intermediate transfer roll 71. At this stage, the portion of the toner remaining on the surface of the photoconductive drum 61 without being transferred at the interface is scraped from the surface, by the photoconductive drum cleaning blade 63. Also, the carrier solution that has adhered to the surface of the intermediate transfer roll 71 together with the toner image is squeezed off from the surface by the carrier solution squeeze roll 72. Such residual carrier solution is then removed from the surface of the carrier solution squeeze roll 72 by the carrier solution cleaning blade 73, and collected in a waste toner box (not shown), to be disposed of as a waste toner.

The intermediate transfer roll 71 and the secondary transfer roll 74 are disposed so as to oppose each other across the paper path for the recording paper P, and mutually abut at a predetermined nip pressure. The toner image transferred to the surface of the intermediate transfer roll 71 is transferred to the recording paper P being carried along the paper path at the interface with the secondary transfer roll 74, by the effect of a transfer electric field, the nip pressure and so on. The intermediate transfer roll 71, interposed between the secondary transfer roll 74 and the photoconductive drum 61, also serves to prevent the nip pressure of the secondary transfer roll 74 from being directly applied to the photoconductive drum 61. Further, the toner that remains on the surface of the intermediate transfer roll 71 after the transference to the recording paper P is removed by the intermediate transfer roll cleaning unit 75, and collected in a waste toner box (not shown), to be disposed of as a waste toner.

The recording paper P on which the toner image has been transferred is carried to the fixing unit 80 along the paper path 14. The fixing unit 80 serves to apply heat and pressure to the recording paper P, so as to fix the toner image (i.e. the printing information) onto the recording paper P, and includes a heat roller 81 that heats up the recording paper P, and a press roller 82 opposing the heat roller 81 across the paper path, so as to hold the recording paper P in cooperation with the heat roller 81, thus to apply a pressure to the recording paper P. The recording paper P, on which the image according to the printing information has been fixed by the fixing unit 80, is discharged through the paper outlet 15.

Although the present invention has been described based on the foregoing embodiment, it is to be understood that the present invention is not limited thereto, but various modifications may be made without departing from the scope of the present invention.

### Second Embodiment

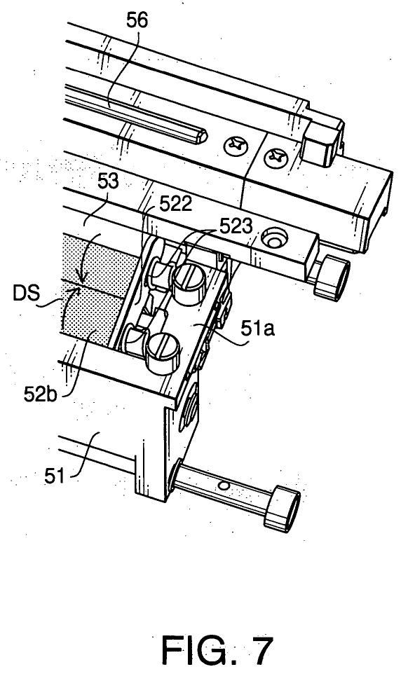

FIG. 7 shows a region around a sealing device for the lateral portions of the space S (i.e. a device corresponding to the elastic members 521 of the first embodiment), in a wet type printer according to a second embodiment. With respect to the wet type printer shown in FIG. 7, the same components as those in the wet type printer 100 according to the first embodiment shown in FIGS. 3 to 6 are given an identical numeral, and detailed description thereof will be omitted.

In the wet type printer according to the second embodiment, a metal plate 522 and two compression coil springs 523 are employed for sealing each of the lateral portions of the space S, and provided adjacent to end faces of the add roller 52b and the measuring roller 53 (the structure at only one end faces being shown in FIG. 7). The metal plate 522 includes, like the elastic member 521, two shaft holes through which the rotary shafts of the two rollers 52b and 53 are inserted.

To achieve a closely sealed state in the lateral portions of the space S in the second embodiment, firstly, the respective rotary shafts of the add roller 52b and the measuring roller 53 are inserted in the shaft holes of the metal plate 522. Then the compression coil springs 523 are attached to the rotary shafts of the rollers 52b and 53. Next, the two rollers 52b and 53 are assembled to the developing solution tank 51. With this structure, the respective compression coil springs 523 are compressed between the wall portion 51a and the metal plate 522. Since the compression coil springs 523, which are compressed, generate a force to reinstate the initial state, acting against the metal plate 522 and the wall portion 51a. As a result, each metal plate 522 is pressed to closely contact the end faces of the two rollers 52b and 53, thus achieving a closely sealed state in the lateral portions of the space S. In the second embodiment, the upper ends of the metal plates 522 are higher than the uppermost portion h₁ of the measuring roller 53.

In the first and second embodiments, the elastic members 521 or the metal plates 522 are provided with the shaft holes for allowing the rotary shafts 52b and 53 to be inserted therein. It may be possible to form cut-away portions such as a D-shaped cut instead of the shaft holes. In this case, the add roller 52b and the measuring roller 53 may be assembled to the developing solution tank 51, and then, the elastic members 521 or the metal plates 522 may be attached adjacent to the end faces of the rollers 52b and 53.

While the add roller 52b and the measuring roller 53 are formed to have the same axial length in the first and second embodiments, these rollers may be configured to have different lengths. In such a case, by forming each of the elastic members 521 or the metal plates 522 to have a stepped portion according to the lengths of the rollers, it is possible to make the elastic members 521 or the metal plates 522 closely fit to the end faces of the rollers 52b and 53.

The present disclosure relates to the subject matter contained in Japanese Patent Application No. 2004-175555, filed on Jun. 14, 2004, which is expressly incorporated herein by reference in its entirety.

1. A wet type image forming apparatus that forms an image with a developing containing toner in a carrier solution, comprising:
a photoconductive drum on which a latent image is formed;
a toner supplying roller that supplies toner to a circumferential surface of the photoconductive drum;
a pair of a developing solution applying roller and a developing solution supplying roller, the developing solution applying roller uniformly applying the developing solution onto a circumferential surface of the toner supplying roller, the developing solution supplying roller contacting the circumferential surface of the developing solution applying roller to supply the developing solution to a circumferential surface of the developing solution applying roller; and
two sidewall members respectively arranged on both sides of the pair of developing solution applying roller and the developing solution supplying roller, the two sidewall members closely contacting side faces of the pair of developing solution applying roller and the developing solution supplying roller at both sides thereof, respectively,
wherein the circumferential surface of the developing solution applying roller, the circumferential surface of the developing solution supplying roller, and the two sidewall members defining a deposition space for depositing the developing solution, the deposition space being configured such that the developing solution is allowed to overflow only in the developing solution supplying roller side.

2. The wet type image forming apparatus according to claim 1,
wherein the developing solution supplying roller and the developing solution applying roller are arranged such that an uppermost portion of the developing solution supplying roller is lower than an uppermost portion of the developing solution applying roller.

3. The wet type image forming apparatus according to claim 2,
wherein the position of the upper ends of the sidewall members are higher than the uppermost portion of the developing solution applying roller.

4. The wet type image forming apparatus according to claim 1, further comprising:
a developing solution collecting tank configured to collect therein the developing solution that has not been consumed; and
a developing solution pickup device that supplies the developing solution collected in the developing solution collecting tank into the space defined by the circumferential surface of the developing solution applying roller, the circumferential surface of the developing solution supplying roller, and the two sidewall members.

5. The wet type image forming apparatus according to claim 1, wherein the developing solution applying roller and the developing solution supplying roller have a substantially same axial length, and are disposed such that the end faces on each axial side are flush with each other.

6. The wet type image forming apparatus according claim 5,
further comprising a casing accommodating at least the developing solution applying roller and the developing solution supplying roller, the housing having a pair of walls respectively facing the end faces of the pair of developing solution applying roller and the developing solution supplying roller, respectively,
wherein the sidewall members comprise elastic members arranged between the pair of walls and the end faces, respectively, the sidewall members being elastically deformed so as to closely contact the respective end faces of the pair of developing solution applying roller and the developing solution supplying roller.

7. The wet type image forming apparatus according to claim 5, wherein the sidewall members include metal plates arranged to closely contact the respective end faces of the pair of developing solution applying roller and the developing solution supplying roller.

8. The wet type image forming apparatus according to claim 7, further comprising:
a housing accommodating at least the pair of developing solution applying roller and the developing solution supplying roller, the housing having a pair of walls respectively facing the end faces of the pair of developing solution applying roller and the developing solution supplying roller, respectively; and
biasing members provided between the metal plates and the end faces of the pair of developing solution applying roller and the developing solution supplying roller to urge the metal plates toward the end faces the pair of developing solution applying roller and the developing solution supplying roller.

9. The wet type image forming apparatus according claim 1,
further comprising a casing accommodating at least the developing solution applying roller and the developing solution supplying roller, the housing having a pair of walls respectively facing the end faces of the pair of developing solution applying roller and the developing solution supplying roller, respectively,
wherein the sidewall members comprise elastic members arranged between the pair of walls and the end faces, respectively, the sidewall members being elastically deformed so as to closely contact the respective end faces of the pair of developing solution applying roller and the developing solution supplying roller.

10. The wet type image forming apparatus according to claim 9,
wherein the elastic members include rubber members.

11. The wet type image forming apparatus according to claim 10,
wherein the rubber members are made of urethane rubber.

12. The wet type image forming apparatus according to claim 10,
wherein the rubber members are made of silicon rubber.

13. The wet type image forming apparatus according to claim 1, wherein the sidewall members include metal plates arranged to closely contact the respective end faces of the pair of developing solution applying roller and the developing solution supplying roller.

14. The wet type image forming apparatus according to claim 13, further comprising:
a housing accommodating at least the pair of developing solution applying roller and the developing solution supplying roller, the housing having a pair of walls respectively facing the end faces of the pair of developing solution applying roller and the developing solution supplying roller, respectively; and
biasing members provided between the metal plates and the end faces of the pair of developing solution applying roller and the developing solution supplying roller to urge the metal plates toward the end faces the pair of developing solution applying roller and the developing solution supplying roller.
